(19) United States
(12) Patent Application Publication
(10) Pub. No.: US 2005/0204401 A1
(43) Pub. Date: Sep. 15, 2005

(54) Dvd virtual machine

(75) Inventors: Declan Patrick Kelly, Eindhoven (NL); Josef Pieter Van Gassel, Eindhoven (NL)

Correspondence Address: PHILIPS INTELLECTUAL PROPERTY & STANDARDS, P.O. BOX 3001, BRIARCLIFF MANOR, NY, 10510, US

(73) Assignee: Koniklijke Philips Electronics N.V., NL-5621 BA Eindhoven (NL)

(21) Appl. No.: 10/515,682

(22) PCT Filed: May 27, 2003
(86) PCT No.: PCT/IB03/02377

§ 371 Date: Nov. 24, 2004

(30) Foreign Application Priority Data
May 27, 2002 (EP) 02077063.2
Dec. 20, 2002 (EP) 02080525.5

(51) Int. Cl. H04N 7/16

(52) U.S. Cl. 725/139; 725/140

(57) ABSTRACT

A transmission system includes at least one receiver 60 and a transmitter 10, 20, 30 for transmitting a title to the receiver. The transmitter also transmits interactive features that enable a user to interact with the title. Thee features interact with the title through a DVD virtual machine. The receiver 60 receives the transmitted title and transmitted interactive features. A controller 250 of the receiver 60 implements the DVD virtual machine to enable execution of the received features in the receiver.

### FIELD OF THE INVENTION

The invention relates to a transmission system including a receiver and a transmitter for transmitting a title and interactive features that enable a user to interact with the title.

### BACKGROUND OF THE INVENTION

New forms of consumer electronics products are continually being developed. Digital TV standards, such as MHP in Europe and DASE in the US, are being extended to allow interactive television. These interactive TV platforms provide the possibility to support interaction with the broadcast content and navigation through the content when the content is stored. The interaction with and navigation through content will collectively be referred to as interactive features. Interactive features are usually based on menus that, for example, enable viewing of a title from a different angle, viewing of additional content, such as commentaries, quizzes, etc., and controlling the rendering sequence such as jumping to scenes, fast-forwarding/reversing, pausing, etc. The broadcast receiver, such as a digital TV or set-top box (STB) may include a storage device for recording the title and interactive features. Each digital TV standard has specified its own format for interaction.

In practice not many titles are broadcast with interactive features. One of the reasons is that the interactive features have to be programmed separately for each specific interactive TV platform.

### SUMMARY OF THE INVENTION

It is an object of the invention to provide an improved transmission system that reduces the effort in developing interactive content.

To meet the object of the invention, a transmission system includes at least one receiver and a transmitter for transmitting a title to the receiver and for transmitting interactive features that enable a user to interact with the title; the features being operative to interact with the title through a storage-medium compliant virtual machine; the receiver being operative to receive the transmitted title and transmitted features; and including a controller for, under control of a virtual machine program, providing the storage-medium compliant virtual machine to enable execution of the received features. The inventors have realized that for many broadcast titles also a prerecorded version exists (e.g. on DVD) with interactive features in format compliant with the virtual machine of the storage medium on which the title has been recorded. Re-programming these interactive features to all digital TV formats and for all titles would be a huge task. Instead, according to the invention, the storage-medium compliant virtual machine is executed by the receiver. This enables transmission of the interactive features in the storage medium format, significantly reducing the efforts in supplying interactive content.

Preferably, the title is broadcast by the transmitter to the receiver (and all other receivers in the system). The title may also be multicast, i.e. sent in one simultaneous operation to a plurality of receivers (but usually not all) that have been selected for receipt. For example, only those receivers that have paid for receipt. In principle, the title may also be directly transmitted to the receiver, e.g. by addressing it to the receiver or using a dedicated link.

As described in the dependent claim 2, the virtual machine program is pre-loaded in the receiver. Since, according to the invention the application needs to be developed only once, it can be pre-loaded. This enables optimal, platform specific coding of the application, reducing costs.

As described in the dependent claim 3, the transmitter provides the virtual machine program to the receiver, for example in the form of an Xlet (Java application optimized for a broadcast receiver platform). In this way, it is possible to control distribution of the application, for example to paying customers, and to easily update the application. A major advantage is that for most platforms, like MHP, a framework for distribution and working of such applications has been defined By using such framework, no further standardization activities are required, which normally are required for interaction between a transmitter and receiver. As described in the dependent claim 5, the receiver may provide a predetermined receiver virtual machine (e.g. compliant with the MHP or DASE virtual machine). This virtual machine differs from the storage virtual machine. The virtual machine program is executed on the receiver virtual machine and, during execution, provides the storage virtual machine to the interactive features.

As described in the dependent claim 4, the receiver downloads the virtual machine program from a download server, such as a website, for example from the web site of the manufacturer of the receiver.

As described in the dependent claim 6, the transmitted title and features may be stored in a storage, such as a hard disk or recordable optical storage for subsequent rendering. In general more interactive features will be available for a stored title then for a real-time rendered title. Preferably, the virtual machine program is also stored in a storage that may, but need not be, the same as used for storing the titles and features. By storing the program, it is also available when the title is rendered at a moment after the transmission.

As described in the dependent claim 8, a first part of the title is intended for real-time rendering, usually with no or limited interactivity during the real-time rendering, where a second part of the title includes additional content accessible through the interactive features. This may include additional material from a different angle, commentaries, deleted scenes, etc.

As described in the dependent claim 9, the first and second part may be broadcast in separate streams of a multiplexed stream. This enables simultaneous reception of both streams where preferably only the stream with the first part is played during live broadcast. To this end, the stream with the second part may be broadcast as a private stream or broadcast as a file, e.g. using the DSM-CC carousel.

Alternatively, the second part may be downloaded from a server, e.g. via a separate network, such as Internet, or via the transmission system.

These and other aspects of the invention are apparent from and will be elucidated with reference to the embodiments described hereinafter.

### BRIEF DESCRIPTION OF THE DRAWINGS

In the drawings:

FIG. 1 shows a block diagram of a digital broadcast system wherein the invention can be used;

FIG. 2 shows a block diagram of a receiver for use in the system;

FIG. 3 shows the DVD virtual machine;

FIG. 4 shows a receiver virtual machine hierarchy; and

FIG. 5 shows an example of a data file according to the invention.

### DETAILED DESCRIPTION OF THE PREFERRED EMBODIMENT

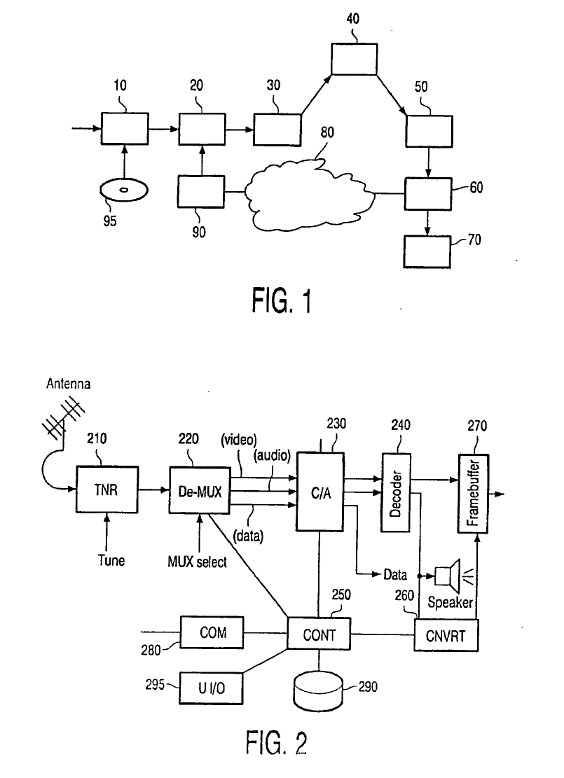

FIG. 1 gives an overview of a digital television system in which the receiver according to the invention can be used. As an example, a system is described wherein the audio/video (A/V) signals are distributed digitally using MPEG-2 compression to compress the AN signals. The system includes an MPEG-2 compressor 10, usually located in a broadcast centre. The compressor receives a digital signal stream (typically a stream of digitized analog or digital video signals). The original signals are supplied by a service provider. The compressor is connected to a scrambler and multiplexer 20. The scrambler scrambles the digital signals of a data stream by encrypting them under control of a content key, as will be described in more detail below. The multiplexer 20 may receive in addition to one or more scrambled or non-scrambled data stream also further digital signals. The multiplexer 20 assembles all the signal and streams into a transport stream and supplies the compressed and multiplexed signals to a transmitter 30 of the broadcast centre. The scrambling and multiplexing functions may be performed in separate units, and if desired at different locations. The multiplexed transport stream maybe supplied from the scrambler/multiplexer 20 to the transmitter 30 using any suitable form of linkage, including telecommunication links. The transmitter 30 transmits electromagnetic signals via an uplink towards a satellite transponder 40, where they are electronically processed and broadcast via a downlink to an earth-based satellite receiver 50, conventionally in the form of a dish of the end user. In the figure, the satellite receiver 50 is connected to an integrated receiver 60. The operation of the receiver 60 is described in more detail below with reference to FIG. 2. The receiver selects the desired signal and presents it in a suitable form to a rendering device, such as a television 70. The signal may also be recorded using a tape, optical disc or hard disk recorder or other suitable recorder. The signal may be supplied to the rendering/recording device in an analog or digital form using well-known distribution systems such as CATV cable, or IEEE 1394. For digital distribution only partial decoding of the transport stream is required, where the de-multiplexed signals are supplied in the MPEG-2 coding using partial transport streams. It will be understood that the main distribution of the AV signals does not need to take place via satellite. Instead other delivery systems (i.e. the physical medium by which one or more multiplexes are transmitted) may be used, such as terrestrial broadcast, cable transmission, combined satellite/cable. The party that distributes the program via the delivery system is sometimes referred as the network provider. It will also he understood that the receiver/decoder 60 may be integrated into the recording or rendering device 70.

A typical system operates as a multi-channel system, implying that the multiplexed 25 can handle A/V information received from a number of (parallel) sources and interacts with the transmitter 30 to broadcast the information along a corresponding number of channels or multiplexed into separate transport streams. In addition to A/V signals, messages or applications or any other sort of digital data may be introduced in some or all of these services/channels interlaced with the transmitted digital audio and video information. As such a transport stream includes one or more services, each with one or more service components. A service component is a mono-media element. Examples of service components are a video elementary stream, an audio elementary stream, a Java application (Xlet), or other data type. A transport stream is formed by time-multiplexing one or more elementary streams and/or data.

Preferably, bidirectional communication is enabled in the system to facilitate interactive applications, such as interactive video, e-commerce and so on, and to enable the receiver to obtain additional information/functionality from a download server, such as a web site. Shown is the use of a wide area network 80, preferably the open Internet, where the added functionality and interactivity may be provided via a web site on a server 90. To enable broadcasting or multicasting of data or applications stored on the server, preferably, the server 90 also has a connection to the multiplexer 20. This may be a direct link but may also be via the Internet. It will be understood that the communication functionality of Internet or similar communication system may be provided in any suitable form. For example, the receiver may communicate via a cable network or satellite connection, directly using Internet protocols. Alternatively, the receiver may have a telephone-based dial-in connection to an access provider that provides access to the Internet. The receiver may, but need not use Internet protocols. If the server 90 does use Internet protocols, protocol conversion may take place, for example using a gateway.

Although the system according to the invention is described for a digital broadcast system, in principle the invention can also be applied for non-broadcast transmissions. For example, the same concepts can be applied easily where a title is supplied to individual receivers, for instance on a pay-per-view basis. The transmission may then take place via a typical broadcast system (but directly addressed) or via other suitable systems, such as a high-bandwidth Internet connection.

FIG. 1 also shows a storage medium, such as a DVD, or solid state memory, which stores AV data. Typically, the AV title is a movie or similar AV data for which enhanced functionality has already been developed once. The storage medium may be of a removable type. Usually, the title was stored in a compressed form, for example using MPEG-2 coding. Movies on DVD use the MPEG-2 Program stream format. For transmission, the title may be changed, for example some parts may be removed to reduce the length, and some other parts, like commercials, may be added. Consequently, the title will usually be re-coded. Using the exemplary digital transmission system of FIG. 1, this is shown by feeding the title through the coder 10. The title will anyhow be multiplexed into the transport stream by the multiplexer 20. At this moment it may also be necessary to transmultiplex the MPEG-2 program stream format used for storing the title to the MPEG-2 Transport Stream format for broadcasting of the title. Of course, the title need not be taken from the storage medium 95 but may also be supplied by a studio in an original version.

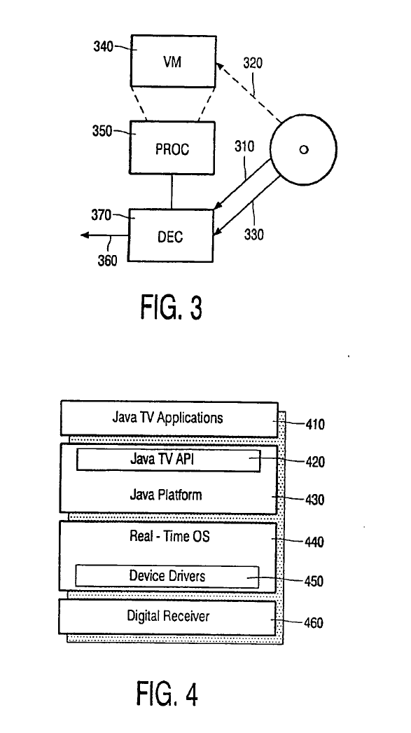

For the title, interactive features are available. Such features may be present on the storage medium 95 as a set of files. The interactive features interact with the title content through the storage-medium virtual machine. FIG. 3 schematically shows the interaction for a storage-medium virtual machine, such as the one used for DVD. The DVD includes the main title 310 and interactive features 320, in the form of DVD files. The DVD may also include additional content 330, such as deleted scenes, the making of, etc., only accessible through the interactive features. The interactive features, such as menus, can be executed on any DVD compliant player. To this end, the features are coded with respect to a DVD virtual machine. The player implements the virtual machine (i.e. it is able to execute the functionality prescribed by the virtual machine). The processor can load an interactive feature (e.g. a menu) automatically and/or in response to a trigger by a user. The processor may also execute a feature (e.g. effect a menu selection) automatically and/or in response to a user action. Execution of the features by a processor of the player typically results in loading and presenting (parts of) the main title 310 or the additional content 330 as an output stream for rendering, where a decoder has decoded the content.

According to the invention, it is enabled to send the DVD interactive features, substantially unmodified, to the broadcast receiver. The receiver is able to receive the transmitted features in addition to the transmitted title. To be able to execute the interactive features, a controller 250 (as shown in FIG. 2) implements the DVD virtual machine to enable execution of the received features. To this end a suitable program, referred to as the virtual machine program, is loaded in the controller. The interactive features interact with the title through the DVD virtual machine. It will be appreciated that the same principle can be applied to other virtual machines then the DVD virtual machine as well as long as there are interactive features and content available for such a virtual machine.

FIG. 2 shows more details of a typical broadcast receiver. The broadcast receiver, preferably, complies with a defined platform like the European MHP (Multi-media Home Platform) or the US DASE platform. The broadcast receiver includes a tuner 210. The tuner 210 extracts a separate tunable Radio Frequency (RF) band usually resulting in an MPEG2 transport stream. Variable data signals are separated from the constant carrier signal by the de-multiplexer 220 (De-MUX). The results often are audio, video and data outputs. The video and audio streams may be fed through a Conditional Access subsystem 230, which determines access grants and may decrypt data. The audio and video streams are fed to a decoder 240, which converts them into signals appropriate for the video and audio rendering or storage devices. This may involve MPEG2 decoding. The receiver also includes the communication interface 280 for bidirectional communication to the web site. Any suitable communications hardware/software may be used for this, including conventional modems for standard telecommunication lines or broadband modems. The bi-directional communication channel facilitates downloading of the interactive features or additional interactive audio/video content from a download server, such as server 90 of FIG. 1, as will be described in more detail below. It also enables applications that interact through a network, such as interactive video, e-commerce and so on. Preferably, Internet protocols are used, for example those defined in the MHP “Internet Access Profile”. The relevant audio/video data retrieved from the web site will be converted by a converter 260 (such as an audio D/A converter and a graphics processor) to a suitable form for presentation to a user, for example via a loudspeaker and/or video display. The video may be combined with the video generated by the decoder 240 into one frame buffer 270. In this way, the additional interactive content may be overlaid (e.g. as sub-titles, or as a Picture-in-Picture), or mixed with the video signal. Output of the decoder can be supplied to a rendering device or storage device for subsequent rendering. Shown is an internal storage 290. Typically, the output is first stored in a frame buffer 270 for subsequent supply to the rendering/storage device. For certain applications the receiver may provide encoded output streams, bypassing the decoder 250. The rendering device may then include the decoder function or the encoded stream may at a later stage be re-supplied to the receiver for further decoding. The encoded data stream may also be recorded in the storage 290 for subsequent rendering A user interface 295 of the receiver enables the receiver to interact with the user. The user interface 295 may include any suitable user input means, such as an Infrared receiver for receiving signals from an IR remote control, a keyboard, or a microphone for voice control. For output, also any suitable form may be used, such as using a small LCD display or using the display of a television, or even audible feedback.

It will be appreciated that the various functions, such as the tuner function 210, the de-muitiplexer function 220, the optional descrambler/decryptor function 230, and the decoder function 240 may be performed using dedicated hardware. Some functions or part of the functions may also be performed by a programmable processing function, for instance using a digital signal processor (DSP) loaded with a suitable program. The various functions within the receiver are operated under control of the controller 250, which typically includes an embedded microprocessor or microcontroller. To keep the figure simple, the control relationship between the controller and the other functions are not shown. Only the role that the controller can have in processing of interactive features and additional interactive AV content are shown.

In principle, the virtual machine program needs to be developed only once. It can be pre-stored in a read-only memory (such as ROM) of the receiver and loaded into the controller when required. It may also be stored in a writeable memory, like flash memory, hard disc, or rewriteable storage. In such a case, it may be received via distribution on a medium like a CD-ROM, it may be transmitted via a communication system like Internet (preferably downloaded firm a general download server or a web site of the set maker), or it may be broadcast by the AV broadcast system, for example as an Java applet (Xlet) in the multiplexed transport stream. It may also be multi-cast to selected receivers, for example those that have subscribed to a particular service. Instead of the transmitter, also the receiver may take the initiative to download the virtual machine program.

In a preferred embodiment, the controller can execute application programs for a predetermined receiver virtual machine, such as MHP or DASE. Such programs may be programmed in a prescribed Java subset. It will be understood that such a receiver virtual machine is distinct from the DVD virtual machine. Preferably, the virtual machine program that provides the DVD virtual machine to the interactive features complies with the receiver virtual machine (e.g. MHP Java virtual machine).

FIG. 4 illustrates a typical software hierarchy (stack) within the broadcast receiver. Java TV applications (also referred to as Xlets) 410 can use the Java API (application programming interface) 420 and the packages from the Java Platform layer 430. The DVD virtual machine is preferably implemented as such an Xlet. The Java applications execute at runtime in the application enviromnent's virtual machine (VM). The Java TV/STB API abstracts the control of receiver-specific hardware. The Real Time Operating System (RTOS) 440 provides the system-level support needed to implement the Java VM and the Java packages. In addition, the RTOS and related device-specific libraries control the receiver hardware 460 through a collection of device drivers 450. The software layers 410 to 450 are all executed by the controller 250 of FIG. 2. If required, the tasks may be distributed over several processors. The software layers, including the Xlets, may be stored in a reprogrammable memory. Part of it, in particular the RTOS, may also be stored in a non-reprogrammable memory, such as ROM.

In a preferred embodiment, the received title and received features are stored in a storage for subsequent rendering, for example in storage 290 of FIG. 2. The virtual machine program may also be stored in a storage for subsequent execution by the controller. This may, but need not be, be the same storage.

The interactive features are stored on DVD as a set of files. Most digital TV broadcast system support broadcasting of files. For example, MHP uses the DSM-CC Object Carousel (Digital Storage Media-Command & Control) to provide a hierarchical file system in a Transport Stream multiplex, whereas DASE uses the DSM-CC data carousel. The DVD interactive features are, therefore, preferably broadcast as files.

Preferably, the transmitted title includes a first part (e.g. the main movie) intended for real-time rendering by the receiver, without (or with limited) interactivity. The interactive content that is only accessible through the interactive features is transmitted as a separate second part, not intended for automatic real-time rendering. Preferably, the first and second parts of the title are broadcast in separate multiplexes of a same stream multiplex. The receiver is then a broadcast receiver operative to receive multiplexed streams as has been described with reference to FIGS. 1 and 2. The second part could be broadcast in the transport stream multiplex as a separate Elementary Stream. To ensure that a receiver, such as a Television or Set Top Box, does not play this elementary Stream automatically during the live broadcast, it may be included as a private stream or broadcast as a file, e.g. using the DSM-CC Object Carousel the DSM-CC data carousel.

Instead of broadcasting both parts, the receiver may also take the initiative to download the second part of the title from a download server. Similarly, the interactive features may be downloaded from a download server. Such downloading may take place via the same transmission system (e.g. as a directly addressed file), but may also take place via other suitable networks, like the public Internet. Access may be restricted, e.g. subject to payment.

For the interactive features and interactive content a distinction may be made between synchronous features, additional information and storage-only features. The synchronous features are features that need to be rendered synchronous (e.g. overlaid) with rendering of parts of the main title. The ‘additional information’ relates to features that do not require synchronous rendering of the interactive content to which it relates, for example an actors biography. These non-synchronous features may but need not have been available for the original stored title. If the title is recorded at the location of the receiver (e g. using a hard disc or recordable optical storage in or connected to the receiver), more advanced features may become available. For example, menus supporting selection of freely selectable parts of the title, fast forwarding, rewinding type of functions may become available. Also a director's commentary may be intermixed with display of the scenes being discussed. Such storage-only features are preferably identified when the features are transmitted. A signal can then be provided to the controller 250 if the title is reproduced from a local storage (such as the internal storage 290 of FIG. 2) so that the controller can enable use of the additional storage-only functionality.

DVD interactive features refer directly to parts of the AV content (e.g. scene access). On DVD this is done using direct addressing, i.e. pointers to locations on disc. If the content is broadcasting such addressing information is not automatically present. A conversion of the identification may be required. In order to understand the conversion, first a description of the DVD identification will be given. DVD-Video defines navigation data to control playback. This logical structure defines the following units (among others):

| Unit | Maximum |
|---|---|
| Title | 99 per disc |
| Program Chain (PGC) | 999 per title |
| Part of Title (PTT) | 999 per title, 99 per sequential PCG title |
| Program (PG) | 99 per Program Chain (PG) |

The meaning of these units is as follows:
Title—movie, TV program or music album
Program Chain—collection of programs or groups of cells linked together to create a sequential presentation
Program—group of cells within a program chain (PGC)
Part of title (PTT)—a division of a title representing a scene, also called a chapter
   For example a DVD-Video disc could contain a single title (the movie) with multiple Program Chains (for different version of the movie). The title is also split into palls (PTTs) which correspond to what the user thinks of as chapters.

Also DVD-Video defines commands for controlling playback (Annex J of the DVD specification, which in some cases will correspond to remote control commands. These commands control playback using the units defined above. Some sample commands are:
Title_Play (Title number)—Play title
PTT_Play (Title number, PTT number)—Play PTT within the title
Time_Play (Title number, Time)—Play title at a specific time
PTT_Search (PIT number)—stop current presentation and start presentation from the beginning of PTT number specified.

DVD interactive features may enable playback of specific parts of the content in non-linear order. The description of these features (whether procedural or declarative) will use the DVD Annex J commands to control playback. The interactive features may also refer to content that is presented along with the main video presentation e.g. subtitles, foreign language soundtrack, script and directors notes while video displayed on part of the screen. This content will need to be synchronized with the DVD-Video and stay consistent with the video content even with user operations such as fast forward/rewind, next/previous chapter. These features can be presented to the user during a TV broadcast without requiring the content to be stored.

In both cases it is necessary to have a mapping between the logical navigation structure on the DVD and the timing in the broadcast. In a preferred embodiment, this takes into account the possibility that the movie has been edited for TV so parts have been deleted or that extra convent has been added to the broadcast (e.g. commercial breaks, movie split with news bulletin).

MHP defines Normal Play Time (NPT) which is included in the Transport Stream and is accessible to the applications. It provides a continuous monotonically increasing time base independent of any timing discontinuities in the broadcast. NPT does not need to be included in a broadcast but is part of MHP and so can be used in this case to define the time relation between the DVD content and the broadcast. The NPT can also be paused for some time e.g. during a commercial break the NPT of the main programme will pause. There may be multiple NPTs in the broadcast but only one can be increasing at any point in time e.g. the NPT of the main programme may be paused during an inserted news bulletin during which a separate NPT will increase. Essentially, the NPT is an offset from the Transport Stream timing (based on PCR) but without discontinuities PCR is an acronym from MPEG-2 Transport Stream. It stands for Program Clock Reference and it is the basic timing in the Transport Stream along with the PTS/DTS times (Presentation Time Stamp and Display Time Stamp). The PCR is repeated in the Transport Stream (e.g. every 100 ms) to give the current time and the PTS/DTS refer to the same timebase as the PCR.

Before an interactive feature is broadcast a mapping table needs to be created that provides a mapping from the DVD-Video presentation structure (or more generally: the addressing structure used for identifying the stored content parts) to the broadcast, where content parts are identified using broadcast timing information. Such a table can be used to re-code the feature before transmitting the feature. In a preferred embodiment, a data file is created that includes the table. The data file is transmitted to the receiver. The details of how this file is coded are not important (e.g. using XML) but the data file does define for the content parts of the original stored title that are present in the broadcast the time relation between the two. In a preferred embodiment, the data file also defines which parts of the DVD content are present in the broadcast (or, reversely, are not present in the broadcast) to enable the controller to disable rendering of information parts on the web site that relate to removed content parts.

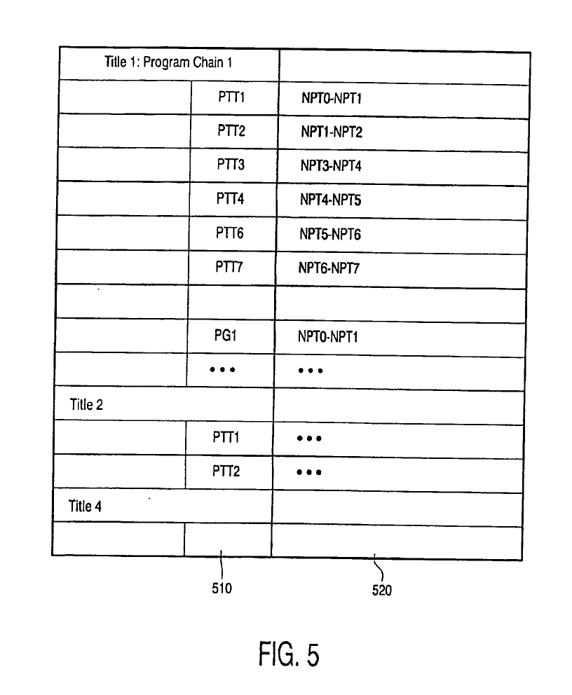

FIG. 5 shows an example of the data file mapping the content part address of DVD (indicated in column 510) to the content part timing (indicated in column 520) in the MHP NPT format. In the example, title 1 is divided in seven chapters PTT1 to PTT7. Chapter PTT5 is removed from the broadcast. In the exemplary data file, it is removed from the data file. It will be understood that it may also still be present in the table, where in column 620 it is made clear that it is not present in the broadcast (e.g. by having no value in column 620). As such the data file indicates explicitly or implicitly which content parts of the title have been removed from the broadcast. Based on such information, the controller can disable rendering of any web-based content that relate to content parts not present in the broadcast/transmitted title. Further, it can be noted that there is a gap in the broadcast content compared to the original stored title: PTT3 starts at timing NPT3 whereas the previous chapter ended at broadcast time NPT2. This gap may be because additional content, like a commercial, has been added in the broadcast that was not present in the original stored content. In the example, also title 3 has been removed in its entirety. Persons skilled in the art will be able to adapt the data file for other storage formats and other broadcast timing formats. As an example, the storage addressing may also be at a more detailed level than chapters, for example at DVD cell level.

The above structure takes the DVD structures and indicates which parts are in the broadcast (or downloaded). Of course an alternative structure would be to start with the broadcast content timeline and indicate for each part which part of the DVD it corresponds to. Depending on what level the interactive features make references to the DVD it may be sufficient to store a subset of this mapping e.g. if the interactive features do not reference Programs (PGs) then there is no need to store the mapping to PGs.

Other systems than MHP may not use the NPT principle, but may have similar mechanisms. If no suitable mechanisms are present, instead a mapping can be given to the timing in the broadcast (based on PCRs) taking into account possible discontinuities. Of course this time information must be available to the Interactive application.

It will also be appreciated that the broadcast may add content for which also support is provided in the interactive features. Such new content parts need to be identified, for example mimicking the DVD addressing format. Preferably, the new parts are not identified using the transmission timing format. By using a format independent of the transmission, it is made easier to re-use the added content for other transmissions/broadcasts that may use a different transmission identification. The conversion data file includes also conversion data for the added content parts.

In a preferred embodiment, the receiver stores the transmitted title in a storage, such as the internal storage 290 of FIG. 2. In storing a transmitted title, typically also a mapping from the broadcast timing to locations on storage, such as a recordable disc, is stored. This allows support for jumping a certain time within the programme and trickplay (for many applications it may be sufficient to store time/location for MPEG-2 I-frames). This additional mapping enables finding a location in the storage based on the timing in the broadcast. For this invention, the interactive features may indicate a location based on, for example, the DVD addressing. The data file indicates a mapping to the broadcast timing and then using the new storage locations it is possible to map again from the broadcast timing to actual locations on disc. If so desired, it is possible to update the data file to provide a direct mapping from the DVD addressing to the addressing on the new storage.

It should be noted that the above-mentioned embodiments illustrate rather than limit the invention, and that those skilled in the art will be able to design many alternative embodiments without departing from the scope of the appended claims. In the claims, any reference signs placed between parentheses shall not be construed as limiting the claim. The words “comprising” and “including” do not exclude the presence of other elements or steps than those listed in a claim. The invention can be implemented by means of hardware comprising several distinct elements, and by means of a suitably programmed computer. Where the system/device/apparatus claims enumerate several means, several of these means can be embodied by one and the same item of hardware. The computer program product may be stored/distributed on a suitable medium, such as optical storage, but may also be distributed in other forms, such as being distributed via the Internet or wireless telecommunication systems.

1. A transmission system including at least one receiver and a transmitter for transmitting a title to the receiver and for transmitting interactive features that enable a user to interact with the title; the features being operative to interact with the title through a storage-medium compliant virtual machine;
the receiver being operative to receive the transmitted title and transmitted features; and including a controller for, under control of a virtual machine program, providing the storage-medium compliant virtual machine to enable execution of the received features.

2. A system as claimed in claim 1, wherein the virtual machine program is pre-loaded in a memory of the receiver.

3. A system as claimed in claim 1, wherein the transmitting system is operative to transmit the virtual machine program to the receiver; the receiver being operative to receive the virtual machine program.

4. A system as claimed in claim 1, wherein the receiver is operative to download the virtual machine program from a download server through a network.

5. A system as claimed in claim 1, wherein the controller is operative to execute application programs for a predetermined receiver virtual machine; the receiver virtual machine being distinct from the storage-medium compliant virtual machine; the virtual machine program being compliant with the receiver virtual machine.

6. A system as claimed in claim 1, wherein the receiver is operative to store the received title and features in a storage for subsequent rendering.

7. A system as claimed in claim 1, wherein the receiver is operative to store the received virtual machine program in a storage for subsequent execution by the controller.

8. A system as claimed in claim 1, wherein the title includes a first part for real-time rendering by the receiver and a second part with interactive content accessible through the interactive features.

9. A system as claimed in claim 8, wherein the transmitting system is operative to broadcast the title, where the first and second part of the title are broadcast as separate streams in a same multiplexed stream; the receiver being a broadcast receiver operative to receive multiplexed streams.

10. A system as claimed in claim 8, wherein the transmitting system is operative to broadcast the first part of the title; the receiver being a broadcast receiver operative to receive the broadcast first part of a title and to download the second part of the title from a download server.

11. A system as claimed in claim 1 wherein the storage-medium compliant virtual machine is a DVD virtual machine.

12. A receiver for use in the system as claimed in claim 1; the receiver being operative to receive a transmitted title and transmitted interactive features that enable a user to interact with the title; the features being operative to interact with the title through a storage-medium compliant virtual machine; the receiver including a controller for, under control of a virtual machine program, providing the storage-medium compliant virtual machine to enable execution of the received features.

13. A virtual machine program product for causing a controller in a receiver for use in a system as claimed in claim 1, to provide a storage-medium compliant virtual machine to enable execution of the received interactive features that enable a user to interact with a received title; the interactive features being operative to interact with the title through the storage-medium compliant virtual machine.
